(19) United States
(12) Patent Application Publication
(10) Pub. No.: US 2013/0290734 A1
(43) Pub. Date: Oct. 31, 2013

(54) SYSTEMS AND METHODS FOR CACHING SECURITY INFORMATION

(71) Applicants: Paul K. BRANTON, Rochdale (GB); Richard J. SOMERFIELD, Cheshire (GB)

(72) Inventors: Paul K. BRANTON, Rochdale (GB); Richard J. SOMERFIELD, Cheshire (GB)

(73) Assignee: APPSENSE LIMITED, Warrington (GB)

(21) Appl. No.: 13/456,623

(22) Filed: Apr. 26, 2012

(51) Int. Cl. H04L 9/00

(52) U.S. Cl. 713/189

(57) ABSTRACT

Systems and methods are provided for caching security information. A method can include receiving security information for a file to be accessed at a device, performing a first hash function on the security information using a salt and a first mixer to compute a key associated with the security information, generating a device identifier (ID) unique to the device, performing a second hash function on the key using the device ID and a second mixer to compute an index associated with the key, wherein the second mixer is different from the first mixer, caching at least one of the security information and the key in a storage medium, wherein the index refers to the at least one of the security information and the key cached in the storage medium, and storing the index with the file.

### CROSS-REFERENCE TO RELATED APPLICATION

This application is related to a co-pending U.S. patent applications Ser. No. ______, entitled “SYSTEMS AND METHODS FOR CACHING SECURITY INFORMATION,” filed on even date herewith. This application is also related to two other co-pending U.S. patent applications Ser. No. ______, entitled “SYSTEMS AND METHODS FOR STORING AND VERIFYING SECURITY INFORMATION,” filed on even date herewith. This application is also related to another two co-pending U.S. patent applications Ser. No. ______, entitled “SYSTEMS AND METHODS FOR DATA ACCESS PROTECTION,” filed on even date herewith. All aforementioned applications are expressly hereby incorporated by reference herein in their entirety.

### BACKGROUND

1. Technical Field

Disclosed systems and methods relate generally to providing security measures in computing systems or networks and, more particularly, to caching security information.

2. Description of the Related Art

Security is an important problem in modern computing systems, especially with the advent of cloud computing. Oftentimes, computer systems protect data access using an encryption mechanism. An encryption mechanism encrypts data with an encryption key so that the encrypted data cannot be retrieved or accessed without a decryption key. If the encryption mechanism is asymmetric, the encryption key is distinct from the decryption key; if the encryption mechanism is symmetric, the encryption key is identical to the decryption key. One common security measure of protecting data, files, or resources against unauthorized access is by associating the data, files, or resources with some form(s) of security information (e.g., a password or a passphrase). One of the popular encryption mechanisms is based on passphrases. A passphrase-based encryption mechanism is a symmetric encryption mechanism that uses a passphrase as both the encryption key and the decryption key. A file can be encrypted using a passphrase, and the encrypted file can be decrypted using the same passphrase. This way, the file can only be decrypted by a party with the correct passphrase.

In the past, the passphrase-based protection worked reasonably well because it was challenging for an unauthorized party to determine the correct passphrase. To an unauthorized party, guessing the correct passphrase from all possible passphrases was not an easy task. Furthermore, trying every candidate passphrase until the computing system grants data access usually required too much computation, and thus, computing time. As the computing technology advanced, however, the speed of computing systems has improved drastically. The improved computing systems provided an unauthorized party the ability to try every candidate passphrase in a reasonable amount of time. Therefore, there is a need in the art to provide systems and methods for improving passphrase-based data protection.

### SUMMARY

In accordance with the disclosed subject matter, systems and methods are provided for storing and verifying security information in computing systems or networks.

Disclosed subject matter includes, in one aspect, a method which includes receiving security information for a file to be accessed at a device, performing a first hash function on the security information using a salt and a first mixer to compute a key associated with the security information, generating a device identifier (ID) unique to the device, performing a second hash function on the key using the device ID and a second mixer to compute an index associated with the key, wherein the second mixer is different from the first mixer, caching at least one of the security information and the key in a storage medium, wherein the index refers to the at least one of the security information and the key cached in the storage medium, and storing the index with the file.

In some embodiments, the security information is a passphrase. In some other embodiments, the method further includes selecting the first mixer and the second mixer based on an output type. In some other embodiments, the method further includes performing the second hash function on the key using the device ID, a second salt, and the second mixer to compute the index. In some other embodiments, the first hash function is the same as the second hash function. In some other embodiments, the method further includes storing the index in at least one of a header or metadata of the file.

In some other embodiments, the method further includes: determining whether the file supports the caching of the security information or the key, setting an indication with the file based on whether the file supports the caching of the security information or the key, if the file supports the caching of the security information or the key, allowing the storing of the index with the file, and if the file does not support the caching of the security information or the key, preventing the storing of the index with the file. In some other embodiments, the method further includes storing the indication as a flag in at least one of a header or metadata of the file. In some other embodiments, the method further includes generating a second device ID unique to a second device, performing the second hash function on the key using the second device ID and the second mixer to compute a second index associated with the key, caching at least one of the security information and the key in a second storage medium on the second device, wherein the second index refers to the at least one of the security information and the key cached in the second storage medium on the second device, and storing the second index with the file.

Disclosed subject matter includes, in another aspect, an apparatus which includes a processor and a memory, wherein the processor is configured to execute a module in the memory to: receive security information for a file to be accessed at a device, perform a first hash function on the security information using a salt and a first mixer to compute a key associated with the security information, generate a device identifier (ID) unique to the device, perform a second hash function on the key using the device ID and a second mixer to compute an index associated with the key, wherein the second mixer is different from the first mixer, cache at least one of the security information and the key in a storage medium, wherein the index refers to the at least one of the security information and the key cached in the storage medium, and store the index with the file.

In some embodiments, the security information is a passphrase. In some other embodiments, the processor is configured to execute the module in the memory further to: select the first mixer and the second mixer based on an output type. In some other embodiments, the processor is configured to execute the module in the memory further to: perform the second hash function on the key using the device ID, a second salt, and the second mixer to compute the index. In some other embodiments, the first hash function is the same as the second hash function. In some other embodiments, the processor is configured to execute the module in the memory further to: store the index in at least one of a header or metadata of the file.

In some other embodiments, the processor is configured to execute the module in the memory further to: determine whether the file supports the caching of the security information or the key, set an indication with the file based on whether the file supports the caching of the security information or the key, if the file supports the caching of the security information or the key, allow the storing of the index with the file, and if the file does not support the caching of the security information or the key, prevent the storing of the index with the file. In some other embodiments, the processor is configured to execute the module in the memory further to: store the indication as a flag in at least one of a header or metadata of the file. In some other embodiments, the processor is configured to execute the module in the memory further to: generate a second device ID unique to a second device, perform the second hash function on the key using the second device ID and the second mixer to compute a second index associated with the key, cache at least one of the security information and the key in a second storage medium on the second device, wherein the second index refers to the at least one of the security information and the key cached in the second storage medium on the second device, and store the second index with the file.

Disclosed subject matter includes, in yet another aspect, a non-transitory computer readable medium having executable instructions operable to cause an apparatus to: receive security information for a file to be accessed at a device, perform a first hash function on the security information using a salt and a first mixer to compute a key associated with the security information, generate a device identifier (ID) unique to the device, perform a second hash function on the key using the device ID and a second mixer to compute an index associated with the key, wherein the second mixer is different from the first mixer, cache at least one of the security information and the key in a storage medium, wherein the index refers to the at least one of the security information and the key cached in the storage medium, and store the index with the file.

In some embodiments, the security information is a passphrase. In some other embodiments, the executable instructions are further operable to cause the apparatus to: select the first mixer and the second mixer based on an output type. In some other embodiments, the executable instructions are further operable to cause the apparatus to: perform the second hash function on the key using the device ID, a second salt, and the second mixer to compute the index. In some other embodiments, the first hash function is the same as the second hash function. In some other embodiments, the executable instructions are further operable to cause the apparatus to: store the index in at least one of a header or metadata of the file.

In some other embodiments, the executable instructions are further operable to cause the apparatus to: determine whether the file supports the caching of the security information or the key, set an indication with the file based on whether the file supports the caching of the security information or the key, if the file supports the caching of the security information or the key, allow the storing of the index with the file, and if the file does not support the caching of the security information or the key, prevent the storing of the index with the file. In some other embodiments, the executable instructions are further operable to cause the apparatus to: store the indication as a flag in at least one of a header or metadata of the file. In some other embodiments, the executable instructions are further operable to cause the apparatus to: generate a second device ID unique to a second device, perform the second hash function on the key using the second device ID and the second mixer to compute a second index associated with the key, cache at least one of the security information and the key in a second storage medium on the second device, wherein the second index refers to the at least one of the security information and the key cached in the second storage medium on the second device, and store the second index with the file.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1A-1C illustrate passphrase enhancement methods in accordance with certain embodiments of the disclosed subject matter.

FIG. 2 illustrates a diagram of a networked communication arrangement in accordance with certain embodiments of the disclosed subject matter.

FIG. 3A illustrates a block diagram of a security information caching system in accordance with certain embodiments of the disclosed subject matter.

FIG. 3B illustrates a detailed block diagram of a caching index generation module in accordance with certain embodiments of the disclosed subject matter.

FIGS. 4A-4B illustrate the storage of caching flags and indexes in accordance with certain embodiments of the disclosed subject matter.

FIG. 5 illustrates one process of caching security information in accordance with certain embodiments of the disclosed subject matter.

FIG. 6 illustrates another process of caching security information in accordance with certain embodiments of the disclosed subject matter.

FIG. 7 illustrates one process of determining whether caching security information is supported in accordance with certain embodiments of the disclosed subject matter.

FIG. 8 illustrates a block diagram of a computing system in accordance with certain embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are only for examples, and that it is contemplated that there are other systems and methods that are within the scope of the disclosed subject matter.

Protecting secure access to data, files, or resources is an important problem in modern computing systems because data, files, or resources can be easily reached via communication networks. Unless access is adequately controlled, confidential information could be compromised in a matter of seconds. One of the popular encryption mechanisms is based on passphrases. A passphrase based encryption mechanism is a symmetric encryption mechanism that uses a passphrase for both encryption and decryption. A file can be encrypted using a passphrase, and the encrypted file can be decrypted using the same passphrase. This way, the file can only be decrypted by a party with the correct passphrase.

Passphrase-based encryption mechanisms have worked reasonably well in the past because it was generally challenging to identify or guess the correct passphrase within a reasonable period of time. As the computation power of computer systems improves over time, however, traditional passphrase-based encryption mechanisms become more and more vulnerable to brute force attacks (i.e., a hacker tries different variations of passphrase to guess the correct passphrase).

Security of passphrase-based encryption mechanisms can be improved through passphrase enhancement. A passphrase enhancement relates to improving an original passphrase so that the modified or enhanced passphrase is harder to identify by a brute force approach. For example, when a user provides a passphrase (e.g., “MyPassword”) to a computing system, the computing system modifies the passphrase such that the enhanced passphrase (e.g., “KLJĤ*%*&̂˜!@908”) is more complex than the original passphrase. Subsequently, the computing system would use the enhanced passphrase to encrypt and decrypt files. Because the passphrases can be enhanced behind the scenes, the passphrase enhancement can be transparent at least to authorized users.

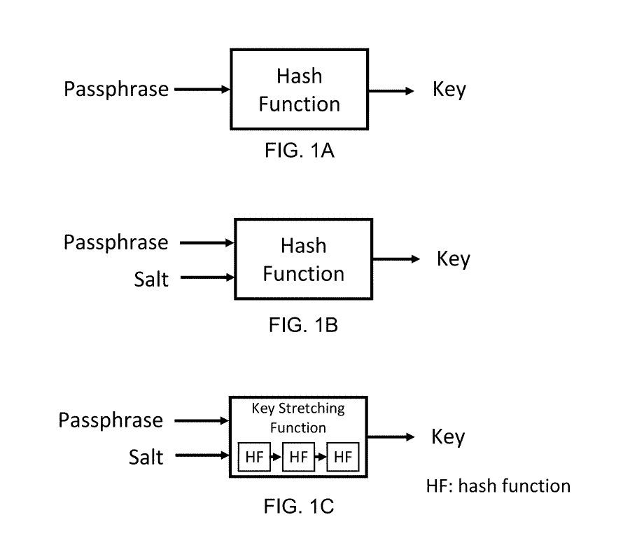

For example, a passphrase can be enhanced using a hash function. A hash function is generally a routine that maps a variable length input to a fixed length output. Examples of a hash function can include a MD2 Message-Digest Algorithm, a MD5 Message-Digest Algorithm, and a Secure Hash Algorithm. As illustrated in FIG. 1A in accordance with certain embodiments, a hash function can take an original passphrase as an input and generate a hash as an output. The output hash can serve as an enhanced passphrase. An enhanced passphrase is sometimes called a key, which is usually a very large number that is extremely difficult to guess. The key can then be used for encrypting/decrypting a target file, data, or resource. Because the enhanced passphrase (i.e., the key) can be significantly more complicated than the original passphrase, it can be significantly harder for a third party to identify the enhanced passphrase by a brute force approach. In most cases, the only reasonable way to breach the encryption mechanism with an enhanced passphrase is to identify the original passphrase and its hash function. If the passphrase-enhancing mechanism (e.g., the hash function) is known, a third party can pre-generate a set of enhanced passphrases based on various hypothetical original passphrases (e.g., all the words in an English dictionary), then use this pre-generated set of enhanced passphrases in a brute force attack. These pre-generated sets are sometimes called Rainbow tables.

Hash-based passphrase enhancements can be further improved using a salt. A salt is a value (e.g., “123” or “MySalt”) that serves as an additional input to passphrase-enhancing mechanism (e.g., a hash function). A salt can be randomly selected or pre-determined. As illustrated in FIG. 1B in accordance with certain embodiments, a salted hash function can take an original passphrase and a salt as inputs and generate a hash as an input. The output hash can serve as an enhanced passphrase, which can be used as the key for encryption/decryption. An enhanced passphrase using a salt can depend on at least three factors: the original passphrase, the salt, and the hash function. A salted hash function can make a brute force attack more difficult and costly, since a rainbow table needs to be generated for each possible salt and the brute force attack needs to go through all rainbow tables.

Brute force attack through rainbow tables can still make passphrase-based encryption mechanisms vulnerable if a third-party has enough computing power and ample time to pre-generate a large number of rainbow tables. One mechanism to thwart the generation of a rainbow table is key stretching. Key stretching is a mechanism that increases the time to compute a hash (e.g., an enhanced key) from a key (e.g., a passphrase or an enhanced passphrase). Key stretching is useful for preventing brute force attacks or preventing the generation of rainbow tables because key stretching increases the required amount of time to perform the brute force attacks or to generate rainbow tables.

Key stretching can involve applying a key stretching module to a key (e.g., a passphrase or an enhanced passphrase). The key stretching module can be subjected to two design criteria. The first design criterion is the computation time. The computation time of the key stretching module should be long enough so that a third party cannot compute the key stretching module numerous times to find the correct passphrase. At the same time, the computation time of the key stretching module should not be so excessive such that the computation delay is noticeable to users. In some embodiments, the computation time of the key stretching module is designed to be about one second. The second design criterion is the prevention of shortcuts. The key stretching module should not allow any shortcuts that could compute the hash in less time than the key stretching module.

In some embodiments, a key stretching module can include multiple concatenated hash functions. For example, as illustrated in FIG. 1C in accordance with certain embodiments, a key stretching module can execute routines to run a single hash function a number of iterations. The key stretching module can sometimes be fixed and cannot be changed within a particular computing system. One way to do so is to fix the predetermined number of iterations, also called the iteration count. For example, the iteration count for iOS 3 is 2,000; the iteration count for iOS 4 is 10,000; the iteration count for Wi-Fi Protected Access (WPA) 2 is 4,096; and the iteration count for BlackBerry OS has been one until a recent update. The fixed iteration count can pose security threats. Because the iteration count is identical on all the machines running the same computing platform and sometimes well-known, a third party can generate a single rainbow table to access all the data in all the machines running the same computing platform. For example, if a third party would like to access multiple encrypted files on iOS 3, the third party can generate a single rainbow table using the iteration count 2,000, and use the same rainbow table to quickly identify the passphrase for all encrypted files on iOS 3. Because a single rainbow table could be used to breach many files, a third party has enough motivation to generate the rainbow table, even if that takes a long time due to key stretching.

Key stretching mechanisms can be enhanced by a technique called dynamic key stretching. Dynamic key stretching is a mechanism for varying the iteration count of a key stretching module. Varying the iteration count of a key stretching module can address deficiencies associated with the traditional fixed-iteration key stretching mechanisms. For example, varying the iteration count of a key stretching module can provide a protection against rainbow tables which are generally tailored to a particular iteration count. Therefore a single rainbow table cannot be used to breach two files associated with two different iteration counts. If two files are encrypted using key stretching modules of different iteration counts, a third party cannot use a single rainbow table to breach both files.

Because a single rainbow table cannot be used, a third party attempting to breach an encryption mechanism with dynamic key stretching can only resort to one of two methods, neither of which is appealing. In the first method, the third party can maintain and use multiple rainbow tables, each of which is tailored to one of different candidate iteration counts. This method is not appealing because rainbow tables are often extremely large and consume a lot of data storage space. In the second method, the third party can determine the iteration count associated with an encrypted file and subsequently generate a rainbow table for the determined iteration count. This method is also not appealing because the rainbow table needs to be generated on-the-fly, which can incur a lot of computation time and overhead. Therefore, varying the iteration count of a key stretching module can provide a protection against rainbow tables.

When a passphrase-based security mechanism is adopted, it is sometimes desirable to securely store (i.e. cache) the passphrase and/or the key. For example, when a passphrase or key is cached, a user does not need to re-enter the passphrase for a file, data, or resource that he/she has previously accessed. Some computing systems (e.g., Microsoft Windows or Mac iOS) can provide one or more secure repositories to store or cache passphrases. One approach of caching passphrases is to store separate passphrases for each protected file, data, or resource in the secure repositories. This approach, however, can cause multiple copies of the same passphrase to be stored when multiple files, data, or resources share the same passphrase. To avoid such duplication, the secure repositories can be configured to store only one copy of each passphrase and/or key. The key is generally used to encrypt/decrypt a file, data, or resource. The passphrase and/or key can be cached (i.e., stored) in the secure repositories. An index can be generated to refer to each passphrase/key stored in the secure repositories; and the index can be stored with the corresponding file, data, or resource. The index can thus provide a link between the file, data, or resource and the associated cached passphrase/key. Later on, when a user or system tries to access a file encrypted with a key, the index to the cached passphrase/key is first retrieved from the file. The index is then used to obtain the cached passphrase/key from the secure repositories. Once the passphrase/key is obtained, it can be used for decrypting the target file. The subject matter disclosed herein provides systems and methods of caching security information (e.g., passphrase) securely and efficiently.

In some embodiments, a first hash function can be performed on a passphrase using a first salt and a first mixer to generate a key. Then a second hash function can be performed on the key using a second salt and a second mixer to generate a hash of the key (i.e., index). The generated hash of key can be used as an index to the passphrase/key cached in a secure repository. The first and second hash functions can be the same or different. The salts used during the first and second hash functions can be the same or different. Even if the same salts are used, the use of different mixers can still provide enhanced security. The first and second mixers can be the same or different and can be randomly selected or pre-determined. Even if the same mixer is used, the use of different salts can still provide enhanced security. Re-using the same salt or mixer can save space for storing a second salt or random mixer.

In other embodiments, a first hash function can be performed on a passphrase using a salt and a first mixer to generate a key. Then a second hash function can be performed on the key using a device identifier (“device ID”) and a second mixer to generate a hash of the key (i.e., index). A device ID can be a value that uniquely identifies a specific device. The uniqueness of the device ID can ensure that the hash of key (i.e., index) generated on a new device is different from the hash of key (i.e. index) generated on a previous device, even if the passphrase/key stays the same. Therefore, the correct passphrase must be re-entered when the protected file is accessed on a new device even if the passphrase stays the same. The device-dependent caching mechanism can provide enhanced security in security information caching.

In some other embodiments, an indication (e.g., a single-bit flag) can be set with the target file, data or resource based on whether the security information caching is supported. The security information caching can be configured to proceed only if the caching is supported. If security information caching is not supported, no caching is done. Disabling security information caching could cause inconvenience but could in the meantime lead to enhanced security, since a user is forced to enter the correct passphrase every time the encrypted file, data, or resource is access.

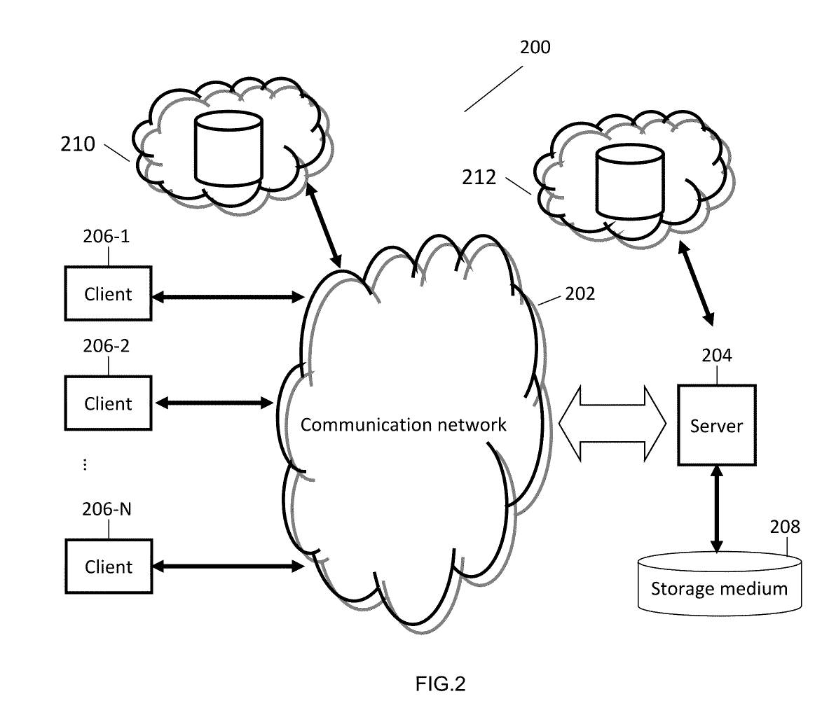

The disclosed subject matter can be implemented in a local and/or networked computing system. FIG. 2 illustrates a diagram of a networked communication arrangement 200 in accordance with an embodiment of the disclosed subject matter. The networked communication arrangement 200 can include a communication network 202, a server 204, and at least one client 206 (e.g., client 206-1, 206-2, . . . 206-N), a physical storage medium 208, and a cloud storage 210 and 212.

Each client 206 can communicate with the server 204 to send data to, and to receive data from, the server 204 across the communication network 202. Although FIG. 2 shows each client 206 being directly coupled to the server 204, each client 206 can be connected to server 204 via any other suitable device, communication network, or combination thereof. For example, each client 206 can be coupled to the server 204 via one or more routers, switches, access points, and/or communication network (as described below in connection with communication network 202). A client 206 can include a desktop computer, a mobile computer, a tablet computer, a cellular device, or any computing systems that are capable of performing computation.

Server 204 is coupled to at least one physical storage medium 208, which is configured to store data for the server 204. Any client 206 can store data in, and access data from, the physical storage medium 208 via the server 204. FIG. 2 shows the server 204 and the physical storage medium 208 as separate components; however, the server 204 and physical storage medium 208 can be combined together. FIG. 2 also shows the server 204 as a single server; however, server 204 can include more than one server. FIG. 2 shows the physical storage medium 208 as a single physical storage medium; however, physical storage medium 208 can include more than one physical storage medium. The physical storage medium 208 can be located in the same physical location as the server 204, at a remote location, or any other suitable location or combination of locations.

FIG. 2 shows two embodiments of cloud storage 210 and 212. Cloud storage 210 and/or 212 can store data from physical storage medium 208 with the same restrictions, security measures, authentication measures, policies, and other features associated with the physical storage medium 208. FIG. 2 shows the cloud storage 212 separate from the communication network 202; however, cloud storage 212 can be part of communication network 202 or another communication network. The server 204 can use only cloud storage 210, only cloud storage 212, or both cloud storages 210 and 212. FIG. 2 shows one cloud storage 210 and one cloud storage 212; however, more than one cloud storage 210, more than one cloud storage 212 or any suitable combination thereof can be used.

The communication network 202 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. FIG. 2 shows the network 202 as a single network; however, the network 202 can include multiple interconnected networks listed above.

In some embodiments, the encryption mechanism can be implemented in the client 206 or the server 204 in an independent manner. For example, a client 206 can include both an encryption module and a decryption module, and the client 206 can locally perform the encryption and decryption of files. In other embodiments, the encryption mechanism can be implemented in a distributed manner. For example, a client 206 can encrypt data using its encryption module, and a server 204 can decrypt the encrypted data using its decryption module. In certain embodiments, the encryption mechanism can be implemented in a centralized manner at a server 204. For example, a client 206 can provide an encryption key or a decryption key to the server 204, and the server 204 uses its encryption or decryption module and the received encryption key or the decryption key to encrypt or decrypt the file.

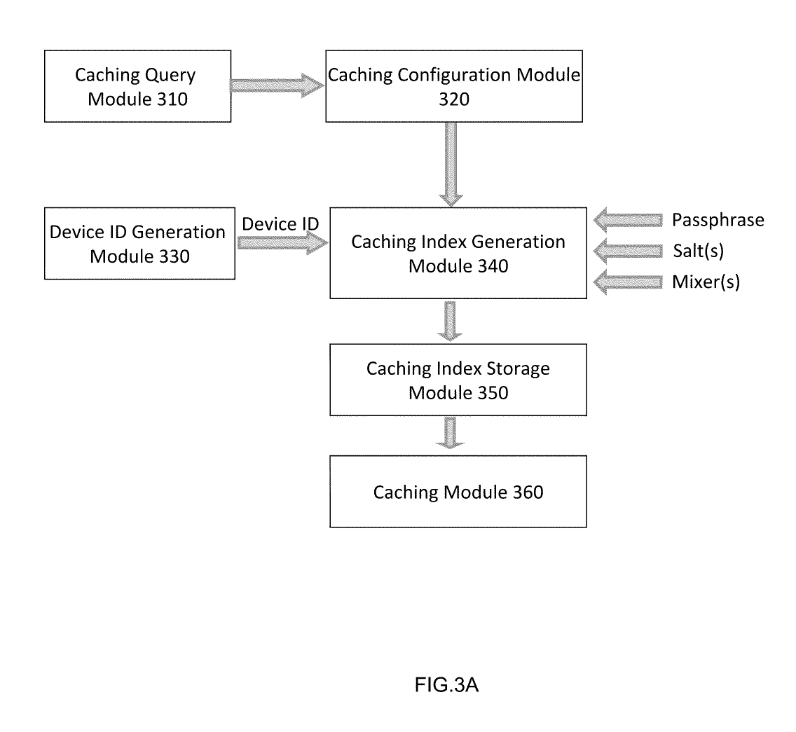

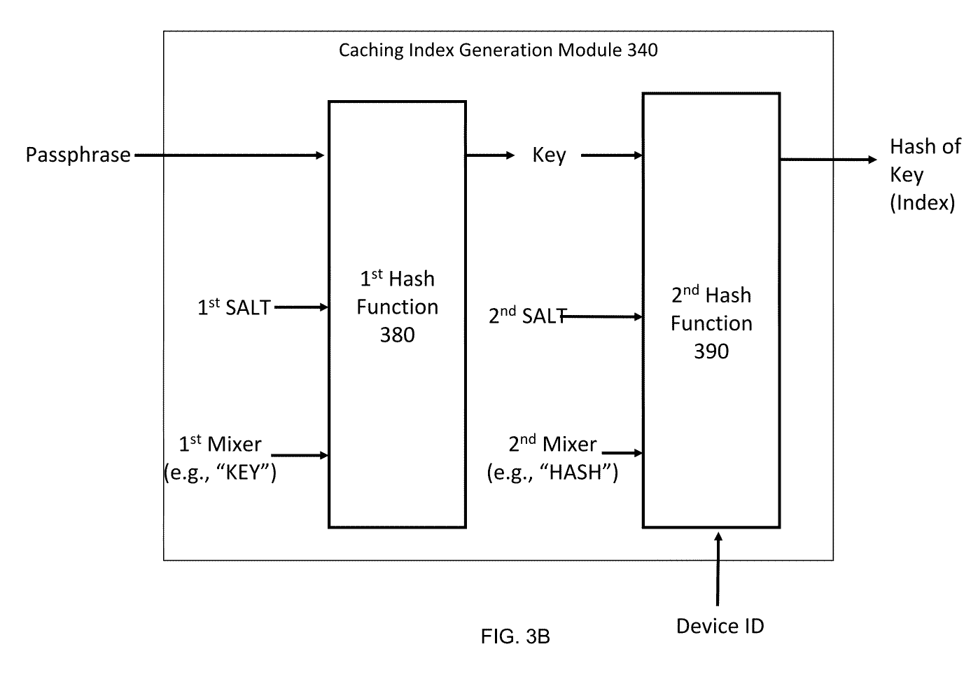

FIG. 3A illustrates a block diagram of a security information caching system in accordance with certain embodiments of the disclosed subject matter. The security information caching system can be implemented using a caching query module 310, a caching configuration module 320, a device ID generation module 330, a caching index generation module 340, a caching index storage module 350, and a caching module 360. In some embodiments, a security information caching system can be implemented in the client 206 or the server 204 in an independent manner. For example, a client 206 or a server 204 can itself include all the modules of a security information caching system and can locally perform all the functionalities. In other embodiments, a security information caching system can be implemented in a distributed manner. For example, a client 206-1 can contain a device ID generation module 330, while another client 206-2 or a server 204 can contain a caching index generation module 340. In some other embodiments, the system can be implemented in a centralized manner in the arrangement 200. For example, a client 206 can provide a passphrase to the server 204, and the server 204 uses its caching index generation module 340 and caching module 360 to cache the security information. As another example, modules in a security information caching system can be distributedly located in multiple clients/servers.

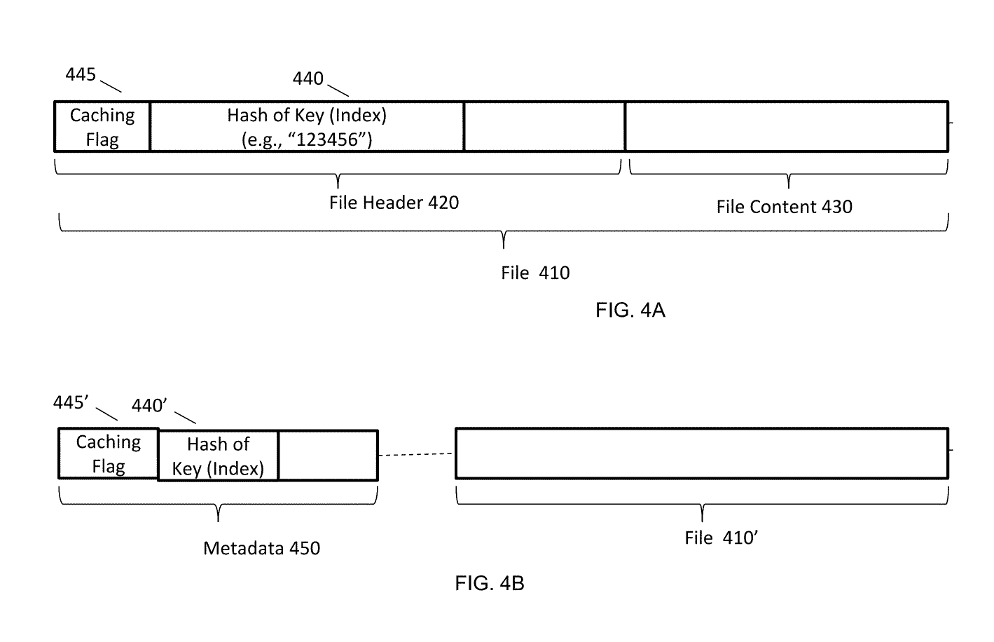

When security information (e.g., a passphrase) to be cached is received, the caching index generation module 340 can generate an index based on at least the security information (e.g., the passphrase). A salt can also be used as an input to the index generation process. In some embodiments, a unique device ID generated by the device ID generation module 330 can also be used as an input to the index generation process. The caching index generation module 340 are discussed in more detail in connection with FIG. 3B. Once an index is generated, the index can be stored with the target file, data, or resource by the caching index storage module 350. In some embodiments, the index can be stored inside the target file, data, or resource itself. For example, as illustrated in FIG. 4A, a file 410 can contain a file header 420 and file content 430. The index 440 can be stored inside a file header 440 of the target file 410. In other embodiments, the index can be stored in a separate data structure associated with the target file, data, or resource. For example, as illustrated in FIG. 4B, the file 410′ can have metadata 450 associated with the file 410′. The index 440′ can be saved in the metadata 450 associated with the target file 410′. In some embodiments, the security information (e.g., passphrase and/or key) can be cached in a secured repository on a local or remote system by the caching module 360 after the index is cached. In other embodiments, the security information (e.g., passphrase and/or key) can be cached in a secured repository on a local or remote system by the caching module 360 after the index is generated but before the index is stored with the target data, file, or resource.

In some situations, caching of security information (e.g., passphrase) is not needed or desired. In these situations, the caching of security information and the generating and/or storing of indexes should not be supported. This improves efficiency and security since a user is required to enter the correct passphrase every time the encrypted file, data, or resource is accessed. The caching query module 310 can first determine if caching of security information is supported for the target file, data, or resource. Next, the caching configuration module 320 can set an indication with the file, data, or resource indicating whether the caching of security information is supported. A caching indication or flag can be, for example, a single-bit flag or any other suitable flag. In some embodiments, the indication (e.g., a single-bit flag) can be stored inside the target file, data, or resource itself. For example, as illustrated in FIG. 4A, the caching flag 445 can be stored inside a file header 440 of the target file 410. In other embodiments, the indication (e.g., a single-bit flag) can be stored in a separate data structure associated with the target file, data, or resource. For example, as illustrated in FIG. 4B, the index 445′ can be saved in metadata 450 associated with the target file 410. If security information caching is supported, the caching flag can be set to ‘1’; otherwise, the caching flag can be set to ‘0’. If the security information caching is supported, the security information caching system can proceed to generate the caching index and cache the security information. If the security information caching is not supported, the security information can forgo the index generation and the security information caching processes, hereby improving efficiency and enhancing security.

FIG. 3B illustrates a detailed block diagram of the caching index generation module 340 in a security information caching system in accordance with certain embodiments of the disclosed subject matter. When a security information to be cached is received, the caching index generation module 340 first generates a key from the security information. One form of such security information is a passphrase (e.g., “MyPassphrase”) for encryption. The security information can be provided by a user of the computing system or by the computing system itself. The security information can be received locally at the computing system or remotely from another computing system. The format and/or the size of the key can be pre-defined, such as 256 bits. The key generation can be via a 1^{st} hash function 380, which can be any suitable hash functions or key stretching mechanisms. The key generation can be with or without a 1^{st} salt. The 1^{st} salt can be randomly selected or predetermined. The 1^{st} salt used during key generation can be saved in the target file, data, or resource itself or in a data structure associated with the target file, data, resource. Additionally, the key generation process (i.e., 1^{st} hash function) can take an additional input (e.g., a 1^{st} mixer) for enhanced security. The 1^{st} mixer can be any data value. The format and/or the size of the 1^{st} mixer can be pre-defined or randomly selected. In some embodiments, the 1^{st} mixer is selected based on the output type. For example, when a key is being generated, the 1^{st} mixer can be set to “KEY.” The key generation process (i.e., 1^{st} hash function) can be repeated multiple times to enhance security.

Once a key is generated from the input security information (e.g., a passphrase), the caching index generation module 340 can then generate a hash of the key. The format and/or the size of the hash of the key can be pre-defined, such as 256 bits. The hash of key generation can be via a 2^{nd} hash function 390, which can be any suitable hash functions or key stretching mechanisms. The 2^{nd} hash function can be the same as or different from the 1^{st} hash function. The hash of key generation can be with or without a 2^{nd} salt. The 2^{nd} salt can be randomly selected or predetermined. The 2^{nd} salt used in the 2^{nd} hash function can be the same as or different from the 1^{st} salt used in the 1^{st} hash function. The 2^{nd} salt used during the hash of key generation can be saved in the target file, data, or resource itself or in a data structure associated with the target file, data, resource. Additionally, the hash of key generation process (i.e., 2^{nd} hash function) can take an additional input (e.g., a 2^{nd} mixer) for enhanced security. The 2^{nd} mixer can be any data value. The format and/or the size of the 2^{nd} mixer can be pre-defined or randomly selected. In some embodiments, the 2^{nd} mixer is selected based on the output type. For example, when a hash of key is being generated, the 2^{nd} mixer can be set to “HASH.” The hash of key generation process (i.e., 2^{nd} hash function) can be repeated multiple times to enhance security. In some embodiments, when the salts used in the 1^{st} and 2^{nd} hash functions are the same but the 2^{nd} mixer is different from the 1^{st} mixer, the difference between the two mixers can provide the enhanced security even if the salts are the same. Re-usage of the same salt of the 1^{st} hash function in the 2^{nd} hash function can save unnecessary storage spaces for salts

In a networked environment, it is common to encrypt a file (or, data, resource, etc.) on one device then access the file on a different device. In other words, a file can be encrypted on a first device and a caching index is generated on the first device then stored with the file; later on, the file with the caching index can be transmitted onto a second device. If the security information (e.g., passphrase) has not changed and the same security information (e.g., passphrase) has already been used on the second device, the cached index would generally still work on the second device and thus no security information (e.g., passphrase) needs to be re-entered. In these situations, however, security can be enhanced by requiring the security information (e.g., a passphrase) be re-entered on the second device, even if the security information (e.g., a passphrase) is the same on the second device.

One approach for enhancing security is to make the caching index device-dependent. In some embodiments, the hash of key generation process (i.e., the 2^{nd} hash function) can take an additional input—a variable that is device dependent. For example, the caching index generation module 340 can receive a device ID from the device ID generation module 330. A device ID can be a Globally Unique ID (GUID) that uniquely identifies a specific device. A device can be a computer, a laptop, a tablet computer, a cellular device (such as a smartphone), or any equipment where a file can be encrypted or accessed. The device ID generation module 330 can generate a device ID based on various hardware and/or software information of a specific device, such as the hard drive serial number, the MAC address of a network card, etc. The device ID for a specific device can be generated spontaneously or on request. In some embodiments, the device ID of a device is only generated once and can be stored for later use. When a device ID is used as an additional input to the hash of key generation process, the generated hash of key is distinct on different devices even if the passphrases, salts, and/or mixers are the same on different devices. The uniqueness of the index on different devices can provide enhanced security since a security information (e.g., a passphrase) must be re-entered when a target file with previously cached security information is accessed on a different device for the first time. After the security information (e.g., a passphrase) has already been re-entered on a new device, a new caching index can be generated and stored for the target file on the new device. Therefore, there is no need to re-enter the security information (e.g., passphrase) again on subsequent accesses.

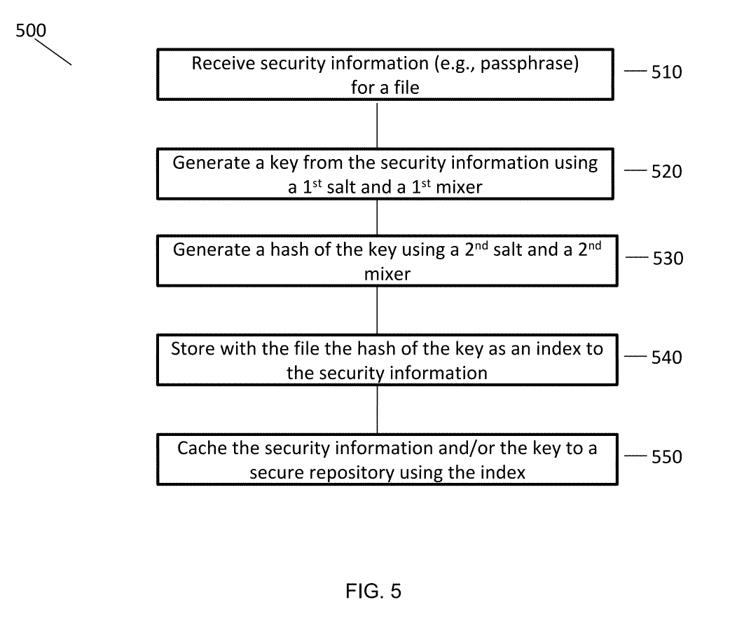

FIG. 5 illustrates one process of caching security information in accordance with certain embodiments of the disclosed subject matter. The process 500 can include more or less steps as illustrated in FIG. 5. The steps in the process 500 can be executed in the same or different sequences as illustrated in FIG. 5

At step 510, the caching index generation module 340 receives security information for encrypting a file. One form of such security information is a passphrase (e.g., “MyPassphrase”) for encryption. The security information can be provided by a user of the computing system or by the computing system itself. The security information can be received locally at the computing system or remotely from another computing system.

At step 520, the caching index generation module 340 generates a key from the security information (e.g., a passphrase) using a first salt and a first mixer. The format and/or the size of the key can be pre-defined, such as 256 bits. The key generation can be via a 1^{st} hash function 380, which can be any suitable hash functions or key stretching mechanisms. The first salt can be randomly selected or predetermined. The first salt used during key generation can be saved in the target file, data, or resource itself or in a data structure associated with the target file, data, resource. The first mixer can be any data value. The format and/or the size of the first mixer can be pre-defined or randomly selected. In some embodiments, the first mixer is selected based on the output type. For example, when a key is being generated, the first mixer can be set to “KEY.” The key generation process (i.e., 1^{st} hash function) can be repeated multiple times to enhance security.

At step 530, the caching index generation module 340 generates a hash of the key from the key using the second salt and a second mixer. The format and/or the size of the hash of the key can be pre-defined, such as 256 bits. The hash of key generation can be via a 2^{nd} hash function 390, which can be any suitable hash functions or key stretching mechanisms. The 2^{nd} hash function 390 can be the same as or different from the 1^{st} hash function 380. The second salt used in generating the hash of the key can be the same or different from the first salt used in generating the key. The second mixer can be any data value. The format and/or the size of the second mixer can be pre-defined or randomly selected. In some embodiments, the second mixer is selected based on the output type. For example, when a hash of key is being generated, the second mixer can be set to “HASH.” The hash of key generation process (i.e., 2^{nd} hash function) can be repeated multiple times to enhance security. The difference between the two mixers can provide the enhanced security even if the salts are the same. Re-usage of the same salt of the 1^{st} hash function in the 2^{nd} hash function can save unnecessary storage spaces for salts.

At step 540, the caching index storage module 350 stores a hash of the key with the file as an index to the security information. In some embodiments, the index can be stored inside the target file, data, or resource itself. For example, as illustrated in FIG. 4A, the index 440 can be stored inside a file header 440 of the target file 410. In other embodiments, the index can be stored in a separate data structure associated with the target file, data, or resource. For example, as illustrated in FIG. 4B, the index 440′ can be saved in metadata 450 of the target file 410′.

At step 550, a caching module 360 can cache the security information and/or the key to a secure repository using the index. The caching of the security information or key can occur before or after the index is stored with the target data, file, or resource.

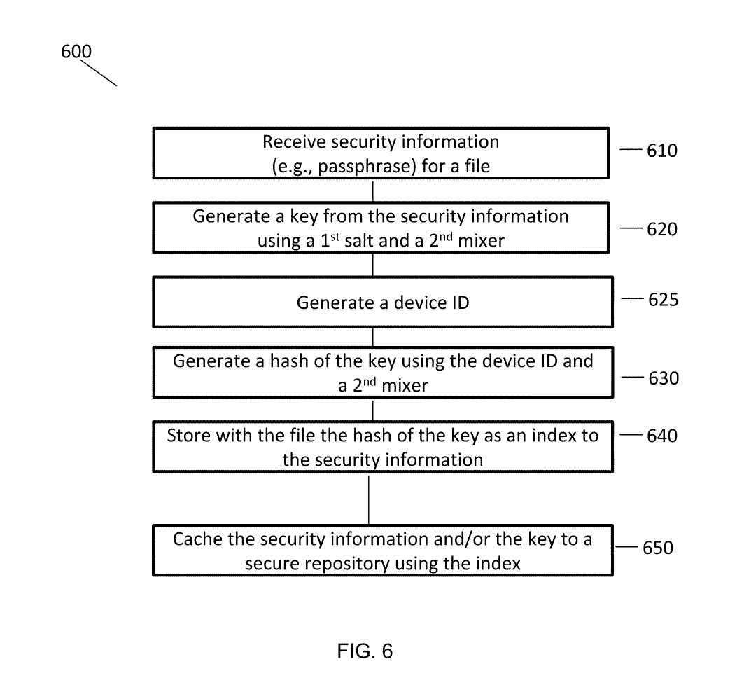

FIG. 6 illustrates another process of caching security information in accordance with certain embodiments of the disclosed subject matter. The process 600 can include more or less steps as illustrated in FIG. 6. The steps in the process 600 can be executed in the same or different sequences as illustrated in FIG. 6.

At step 610, the caching index generation module 340 receives security information for encrypting a file. One form of such security information is a passphrase (e.g., “MyPassphrase”) for encryption. The security information can be provided by a user of the computing system or by the computing system itself. The security information can be received locally at the computing system or remotely from another computing system.

At step 620, the caching index generation module 340 generates a key from the security information (e.g., a passphrase) using a first salt and a first mixer. The format and/or the size of the key can be pre-defined, such as 256 bits. The key generation can be via a 1^{st} hash function 380, which can be any suitable hash functions or key stretching mechanisms. The first salt can be randomly selected or predetermined. The first salt used during key generation can be saved in the target file, data, or resource itself or in a data structure associated with the target file, data, resource. The first mixer can be any data value. The format and/or the size of the first mixer can be pre-defined or randomly selected. In some embodiments, the first mixer is selected based on the output type. For example, when a key is being generated, the first mixer can be set to “KEY.” The key generation process (i.e., 1^{st} hash function) can be repeated multiple times to enhance security.

At step 625, the device ID generation module 330 generates a device ID. A device ID can be a Globally Unique ID (GUID) that uniquely identifies a specific device. A device can be a computer, a laptop, a tablet computer, a cellular device (such as a smartphone), or any equipment where a file can be encrypted or accessed. The device ID generation module 330 can generate a device ID based on various hardware and/or software information of a specific device, such as the hard drive serial number, the MAC address of a network card, etc. The device ID for a specific device can be generated spontaneously or on request. In some embodiments, the device ID of a device is only generated once and can be stored for later uses.

At step 630, the caching index generation module 340 generates a hash of the key from the key using the device ID and a second mixer. The format and/or the size of the hash of the key can be pre-defined, such as 256 bits. The hash of key generation can be via a 2^{nd} hash function 390, which can be any suitable hash functions or key stretching mechanisms. The 2^{nd} hash function can be the same as or different from the 1^{st} hash function. The second mixer can be any data value. The format and/or the size of the second mixer can be pre-defined or randomly selected. The 2^{nd} hash function can optionally take a second salt as an additional input. The second salt can be the same or different from the first salt used in generating the key. In some embodiments, the second mixer is selected based on the output type. For example, when a hash of key is being generated, the second mixer can be set to “HASH.” The hash of key generation process (i.e., 2^{nd} hash function) can be repeated multiple times to enhance security. The difference between the two mixers can provide the enhanced security even if the salts are the same. Re-usage of the same salt of the 1^{st} hash function 380 in the 2^{nd} hash function 390 can save unnecessary storage spaces for salts. When the device ID is used as an additional input to the hash of key generation process, the generated hash of key is distinct on different devices even if the passphrases, salts, and/or mixers are the same on different devices. This index uniqueness on different devices can provide enhanced security since a security information (e.g., a passphrase) must be re-entered when a target file with previously cached security information is accessed on a different device the first time. After the security information (e.g., a passphrase) has already been re-entered on a new device, a new caching index can be generated and stored for the target file on the new device; therefore there is no need to re-enter the security information (e.g., passphrase) again on subsequent accesses.

At step 640, the caching index storage module 350 stores a hash of the key with the file as an index to the security information. In some embodiments, the index can be stored inside the target file, data, or resource itself For example, as illustrated in FIG. 4A, the index 440 can be stored inside a file header 440 of the target file 410. In other embodiments, the index can be stored in a separate data structure associated with the target file, data, or resource. For example, as illustrated in FIG. 4B, the index 440′ can be saved in metadata 450 of the target file 410.

At step 650, a caching module 360 can cache the security information and/or the key to a secure repository using the index. The caching of the security information or key can occur before or after the index is stored with the target data, file, or resource.

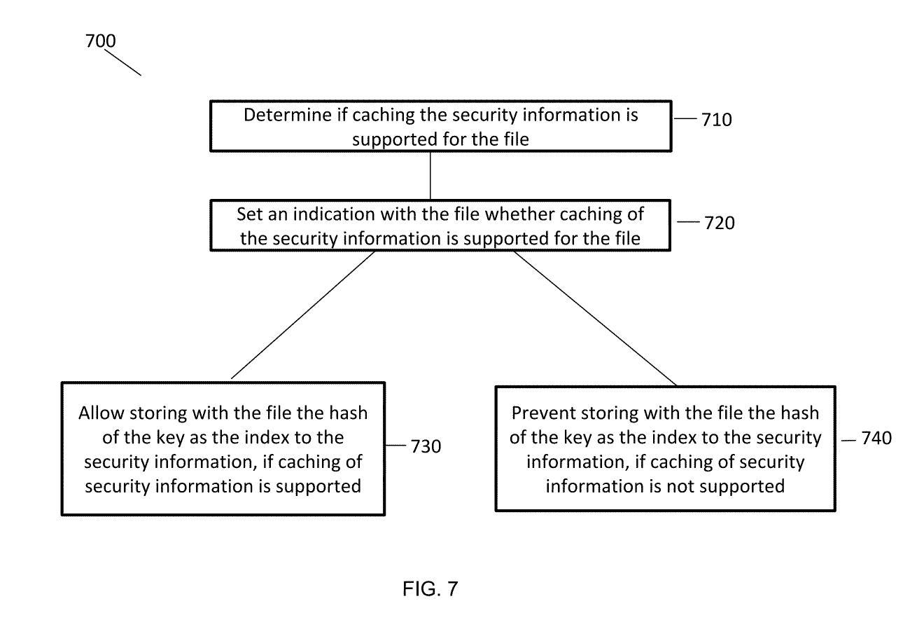

In some situations, caching of security information (e.g., passphrase) is not needed or desired. In these situations, caching of security information and generating/storing of indexes should not be supported and should therefore be avoided to improve efficiency and security. FIG. 7 illustrates one process of determining whether caching security information is supported in accordance with certain embodiments of the disclosed subject matter.

At step 710, the caching query module 310 determines whether caching of security information is supported. Whether a file supports caching security information (e.g., passphrase) can be a user preference, a system-wide preference, or a file-specific preference.

At step 720, the caching configuration module 320 sets an indication with the file whether caching of security information is supported. A caching indication can be, for example, a single-bit flag. In some embodiments, the indication (e.g., a single-bit flag) can be stored inside the target file, data, or resource itself For example, as illustrated in FIG. 4A, the caching flag 445 can be stored inside a file header 440 of the target file 410. In other embodiments, the indication (e.g., a single-bit flag) can be stored in a separate data structure associated with the target file, data, or resource. For example, as illustrated in FIG. 4B, the index 445′ can be saved in metadata 450 of the target file 410′. If security information caching is supported, the caching flag can be set to ‘1’; otherwise, the caching flag can be set to ‘0’.

At step 730, if the security information caching is supported, storing the hash of the key as the index to the security information with the file is allowed. The process 700 can then proceed to processes 500 or 600 described in FIGS. 5 and 6.

At step 740, if the security information caching is not supported, storing the hash of the key as the index to the security information with the file is prevented. This improves efficiency and enhances security because it prevents any unnecessary index generation and security information caching.

The steps in processes 500, 600, and 700 can be performed on one local computing system, on one or more remote computing system, or on a combination of local and remote computing systems. As an example, a computing system can receive security information for caching locally, and then transmit the security information to a remote computing system that handles the index generation steps.

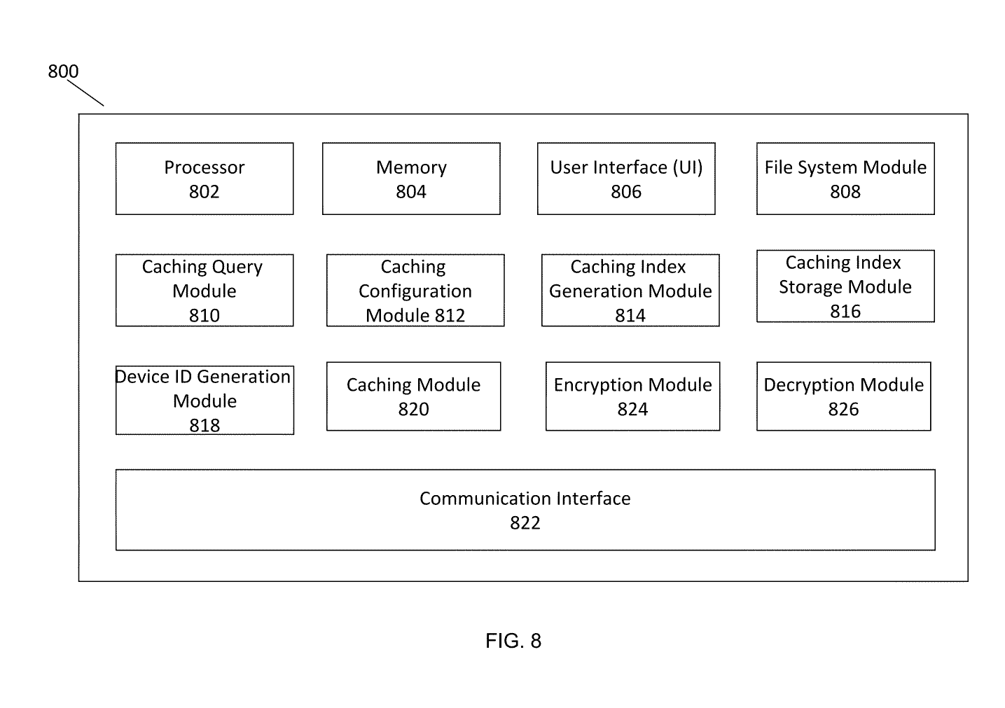

FIG. 8 illustrates a block diagram of a computing system in accordance with certain embodiments of the disclosed subject matter. The computing system 800 can serve as a client 206, a server 204, or both in the communication arrangement 200. The computing system 800 can include at least one processor 802 and at least one memory 804. The processor 802 can be either software or hardware or a combination. The processor 802 can be a general processor or be an application specific hardware (e.g., an application specific integrated circuit (ASIC), programmable logic array (PLA), field programmable gate array (FPGA), or any other integrated circuit). The processor 802 can execute computer instructions or computer code to perform desired tasks. The memory 804 can be a transitory or non-transitory computer readable medium, such as flash memory, a magnetic disk drive, an optical drive, a programmable read-only memory (PROM), a read-only memory (ROM), or any other memory or combination of memories. The computing system 800 can also include a caching query module 810, a caching configuration module 812, a caching index generation module 814, a caching index storage module 816, a device ID generation module 818, and a caching module 820, all of which can be implemented in software or hardware or a combination of both. The description of these modules and their functionalities can be found in the description of their counterparts in FIGS. 3A and 3B. The computing system 800 can also include an encryption module 824 for encrypting files, data, or resources, and a decryption module 826 for decrypting files, data, or resources.

The computing system 800 can also include a user interface (UI) 806, a communication interface 822, and a file system module 808. The UI 806 can provide an interface for users to interact with the computing system 800 in order to provide and/or receive data to/from users. The communication interface 822 can allow the computing system 800 to communicate with external resources (e.g., a network or a remote client/server). The file system module 808 can be configured to maintain a list of all data files, including both local data files and remote data files, in every folder in a file system. The file system module 808 can also be configured to maintain a list of all remote files that have previously been downloaded. The file system module 808 can be further configured to coordinate with the memory 804 to store local data files, remote data files that have been downloaded from a remote server, information about the data files, such as metadata, and any other suitable information about the data files.

The caching query module 810, the caching configuration module 812, the caching index generation module 814, the caching index storage module 816, the device ID generation module 818, the caching module 820, the UI 806, the communication interface 822, the encryption module 824, the decryption module 826, and the file system module 808 can be implemented in software or hardware or in a combination. They can be implemented as separate modules or as one or more indistinguishable modules. In some embodiments, the computer system 800 can include additional modules, fewer modules, or any other suitable combination of modules that perform any suitable operation or combination of operations.

The disclosed systems and methods, as illustrated by examples above, can improve the efficiency of storing and verifying security information (e.g., passphrase). In some embodiments, security information can be verified before a lengthy and costly downloading and/or decryption process finishes. In some embodiments, security information can be verified before any portion of the target data/file/resource itself is downloaded.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method comprising:
receiving security information for a file to be accessed at a device;
performing a first hash function on the security information using a salt and a first mixer to compute a key associated with the security information;
generating a device identifier (ID) unique to the device;
performing a second hash function on the key using the device ID and a second mixer to compute an index associated with the key, wherein the second mixer is different from the first mixer;
caching at least one of the security information and the key in a storage medium, wherein the index refers to the at least one of the security information and the key cached in the storage medium; and
storing the index with the file.

2. The method of claim 1 wherein the security information is a passphrase.

3. The method of claim 1 further comprising selecting the first mixer and the second mixer based on an output type.

4. The method of claim 1 further comprising performing the second hash function on the key using the device ID, a second salt, and the second mixer to compute the index.

5. The method of claim 1 wherein the first hash function is the same as the second hash function.

6. The method of claim 1 further comprising storing the index in at least one of a header or metadata of the file.

7. The method of claim 1, further comprising:
determining whether the file supports the caching of the security information or the key;
setting an indication with the file based on whether the file supports the caching of the security information or the key;
if the file supports the caching of the security information or the key, allowing the storing of the index with the file; and
if the file does not support the caching of the security information or the key, preventing the storing of the index with the file.

8. The method of claim 7 further comprising storing the indication as a flag in at least one of a header or metadata of the file.

9. The method of claim 1 further comprising:
generating a second device ID unique to a second device;
performing the second hash function on the key using the second device ID and the second mixer to compute a second index associated with the key;
caching at least one of the security information and the key in a second storage medium on the second device, wherein the second index refers to the at least one of the security information and the key cached in the second storage medium on the second device; and
storing the second index with the file.

10. An apparatus comprising:
a processor; and
a memory, wherein the processor is configured to execute a module in the memory to:
receive security information for a file to be accessed at a device;
perform a first hash function on the security information using a salt and a first mixer to compute a key associated with the security information;
generate a device identifier (ID) unique to the device;
perform a second hash function on the key using the device ID and a second mixer to compute an index associated with the key, wherein the second mixer is different from the first mixer;
cache at least one of the security information and the key in a storage medium, wherein the index refers to the at least one of the security information and the key cached in the storage medium; and
store the index with the file.

11. The apparatus of claim 10 wherein the security information is a passphrase.

12. The apparatus of claim 10 wherein the processor is configured to execute the module in the memory further to: select the first mixer and the second mixer based on an output type.

13. The apparatus of claim 10 wherein the processor is configured to execute the module in the memory further to: perform the second hash function on the key using the device ID, a second salt, and the second mixer to compute the index.

14. The apparatus of claim 10 wherein the first hash function is the same as the second hash function.

15. The apparatus of claim 10 wherein the processor is configured to execute the module in the memory further to: store the index in at least one of a header or metadata of the file.

16. The apparatus of claim 10 wherein the processor is configured to execute the module in the memory further to:
determine whether the file supports the caching of the security information or the key;
set an indication with the file based on whether the file supports the caching of the security information or the key;
if the file supports the caching of the security information or the key, allow the storing of the index with the file; and
if the file does not support the caching of the security information or the key, prevent the storing of the index with the file.

17. The apparatus of claim 16 wherein the processor is configured to execute the module in the memory further to: store the indication as a flag in at least one of a header or metadata of the file.

18. The apparatus of claim 10 wherein the processor is configured to execute the module in the memory further to:
generate a second device ID unique to a second device;
perform the second hash function on the key using the second device ID and the second mixer to compute a second index associated with the key;
cache at least one of the security information and the key in a second storage medium on the second device, wherein the second index refers to the at least one of the security information and the key cached in the second storage medium on the second device; and
store the second index with the file.

19. A non-transitory computer readable medium having executable instructions operable to cause an apparatus to:
receive security information for a file to be accessed at a device;
perform a first hash function on the security information using a salt and a first mixer to compute a key associated with the security information;
generate a device identifier (ID) unique to the device;
perform a second hash function on the key using the device ID and a second mixer to compute an index associated with the key, wherein the second mixer is different from the first mixer;
cache at least one of the security information and the key in a storage medium, wherein the index refers to the at least one of the security information and the key cached in the storage medium; and
store the index with the file.

20. The non-transitory computer readable medium of claim 19 wherein the security information is a passphrase.

21. The non-transitory computer readable medium of claim 19 wherein the executable instructions are further operable to cause the apparatus to: select the first mixer and the second mixer based on an output type.

22. The non-transitory computer readable medium of claim 19 wherein the executable instructions are further operable to cause the apparatus to: perform the second hash function on the key using the device ID, a second salt, and the second mixer to compute the index.

23. The non-transitory computer readable medium of claim 19 wherein the first hash function is the same as the second hash function.

24. The non-transitory computer readable medium of claim 19 wherein the executable instructions are further operable to cause the apparatus to: store the index in at least one of a header or metadata of the file.

25. The non-transitory computer readable medium of claim 19 wherein the executable instructions are further operable to cause the apparatus to:
determine whether the file supports the caching of the security information or the key;
set an indication with the file based on whether the file supports the caching of the security information or the key;
if the file supports the caching of the security information or the key, allow the storing of the index with the file; and
if the file does not support the caching of the security information or the key, prevent the storing of the index with the file.

26. The non-transitory computer readable medium of claim 25 wherein the executable instructions are further operable to cause the apparatus to: store the indication as a flag in at least one of a header or metadata of the file.

27. The non-transitory computer readable medium of claim 19 wherein the executable instructions are further operable to cause the apparatus to:
generate a second device ID unique to a second device;
perform the second hash function on the key using the second device ID and the second mixer to compute a second index associated with the key;
cache at least one of the security information and the key in a second storage medium on the second device, wherein the second index refers to the at least one of the security information and the key cached in the second storage medium on the second device; and
store the second index with the file.
